(19) United States
(12) Patent Application Publication
(10) Pub. No.: US 2017/0138460 A1
(43) Pub. Date: May 18, 2017

(54) PLANETARY GEARING HAVING AN EMERGENCY LUBRICATING DEVICE

(71) Applicants: ZF Friedrichshafen AG, Friendrichshafen (DE); ZF WIND POWER ANTWERPEN N.V., Lommel (BE)

(72) Inventors: Rik BEQUÉ, Wingene (BE); Nico DE BIE, Avelgem (BE); Sander GOETHALS, Balegem (BE)

(73) Assignees: ZF Friedrichshafen AG, Friedrichshafen (DE); ZF WIND POWER ANTWERPEN N.V., Lommel (BE)

(21) Appl. No.: 15/318,774

(22) PCT Filed: May 26, 2015
(86) PCT No.: PCT/EP2015/061498

§ 371 Date: Dec. 14, 2016

(30) Foreign Application Priority Data
Jun. 27, 2014 (DE) 10 2014 212 487.5

(51) Int. Cl. F16H 57/04; F03D 80/70; F03D 15/00

(52) U.S. Cl. CPC F16H 57/0427; F16H 57/0457; F16H 57/0486; F16H 57/0424; F16H 57/0454; F03D 15/00; F03D 80/70; F05B 2260/40311; F05B 2260/98

(57) ABSTRACT

A transmission for a wind turbine has a planetary gearset with a fixed sealing surface and at least one cavity. The gearset includes a rotating planetary carrier or a rotating ring gear. The cavity is fixed relative to the carrier or ring gear and has at least one opening. The transmission has an oil reservoir. The carrier or ring gear can rotate to at least three positions. By rotating, the carrier or ring gear can move from the first to the second position and from the second to the third position. In the first position of the carrier or ring gear, oil can flow from the oil reservoir through the opening into the cavity and in the third position the oil can flow through the opening out of the cavity. In the second position of the carrier or ring gear the opening is closed by the sealing surface.

This application is a National Stage completion of PCT/EP2015/061498 filed May 26, 2015, which claims priority from German patent application serial no. 10 2014 212 487.5 filed Jun. 27, 2014.

### FIELD OF THE INVENTION

The invention concerns a transmission for a wind.

### BACKGROUND OF THE INVENTION

For the supply of lubricant to the transmission of a wind turbine, as a rule an electric pump is used. However, this can only maintain the lubricant supply to the transmission so long as electrical energy is available. In order to compensate for a breakdown of the electric lubricant pump, the electric lubricant pump is often combined with a mechanical lubricant pump. In the event of a failure of the electrical energy supply, the mechanical lubricant pump remains functional. Thus, the transmission can be supplied with lubricant until the wind turbine has come to a stop. Moreover, under certain operating conditions (idling, alternating operation) it is possible to switch off the electric pump, while the lubricant supply is ensured by the mechanical pump. This saves electrical energy.

Although mechanical lubricant pumps have proved their worth for emergency lubricant supply purposes, they have a number of disadvantages. For example, the additional lubricant pump increases the cost of the transmission. In addition a mechanism is required for decoupling the mechanical pump during normal operation, i.e. when the electric pump is operating correctly, and switching it on if the electric lubricant pump fails. During alternating operation the mechanical pump has to be adapted to the alternating rotational direction by means of an elaborate and costly switching mechanism. Not least, a mechanical lubricant pump takes up not inconsiderable space.

Known from the prior art are systems in which oil for the supply of lubrication sites is conveyed within the transmission in accordance with the principle of Chinese pumps. In this case rotating components in the transmission are provided with pockets, each of which has an opening. When the pockets dip into an oil reservoir they fill up with oil. As a consequence of the rotation of the rotating components the pockets change their positions and the result of this is that the oil flows out from the pockets again in the opposite direction. This oil is collected and passed on to the lubrication sites that need to be supplied.

From the document DE 10 2011 088 644 A1 a similar principle is known, in which a rotating transmission component is provided with pocket-like sections. Oil collects in these pocket sections. The pocket sections have outlet openings through which the oil in the pockets is forced out by the centrifugal force produced by the rotation of the component, and distributed in the transmission.

Neither of the systems—the release of oil due to simple change in the position of the pocket sections and the distribution of oil by centrifugal force—enables the oil to be delivered in a targeted manner. For example, the position of the pocket sections changes continuously. Accordingly, the oil flows out through the outlet openings also continuously. The centrifugal forces act independently of the rotational angle. Consequently, the oil is distributed uniformly along the circumference of the rotating component. With both systems it is not possible to release the oil in a controlled manner such that it passes into a conduction system without leakage losses.

### SUMMARY OF THE INVENTION

The purpose of the present invention is to provide an emergency lubrication device for a transmission, in particular the transmission of a wind turbine, which device avoids the disadvantages inherent in the systems known from the prior art.

This objective is achieved by a transmission having the characteristics described below.

Such a transmission comprises at least one planetary gearset, at least one sealing surface and at least one cavity. The planetary gearset comprises a sun gear, a plurality of planetary gearwheels and a ring gear. The planetary gearwheels are mounted to rotate on a planetary carrier. The planetary gearset can be made as a minus planetary gearset or as a plus planetary gearset. In a minus planetary gearset all the planetary gearwheels mesh with both the sun gear and the ring gear. In a plus planetary gearset each of the planetary gearwheels meshes with either the sun gear or the ring gear. In that case at least one of the planetary gearwheels is designed to mesh with the sun gear and at least one of the planetary gearwheels is designed to mesh with the ring gear.

The planetary carrier or the ring gear are designed to rotate. This means that the planetary carrier or the ring gear can rotate relative to any positionally fixed component of the transmission. A positionally fixed component is a component that does not move. Every positionally fixed or static component of the transmission is positionally fixed and does not move relative to any other positionally fixed and static component of the transmission. In particular, the transmission housing is preferably arranged positionally fixed.

According to the invention, the sealing surface is also positionally fixed.

The cavity is a hollow space, i.e. a volume enclosed by a solid material in a structure. According to the invention, relative to the rotating planetary carrier or the rotating ring gear the cavity is rotationally fixed. This means that the cavity and the rotating planetary carrier or the cavity and the rotating ring gear do not move relative to one another, but can rotate about a common rotational axis.

The cavity has at least one opening. This opening connects the volume enclosed by the structure, which constitutes the cavity, to a surrounding volume or to the surroundings.

The transmission is designed to accommodate an oil reservoir, known as the oil sump. For this, for example, part of the transmission such as the transmission housing can be designed as an oil tank, i.e. a tank in which the oil reserve accumulates.

The rotating planetary carrier or the rotating ring gear can adopt at least a first position, at least a second position and at least a third position. The first, second and third positions are each characterized by a particular rotational angle of the rotating planetary carrier or the rotating ring gear. The rotational angle adopted by the rotating planetary carrier or the rotating ring gear in the first position differs from the rotational angle of the rotating planetary carrier or rotating ring gear in the second position and in the third position. Correspondingly, the rotational angle adopted by the rotating planetary carrier or the rotating ring gear in the second position differs from the rotational angle adopted by the rotating planetary carrier or the rotating ring gear in the third position. By rotation, the rotating planetary carrier or the rotating ring gear can be moved from the first position to the second position and from the second position to the third position. Since the rotating planetary carrier or rotating ring gear can be turned all the way round through 360°, it is also possible by turning the rotating planetary carrier or rotating ring gear to move it back to the first position.

The first position is a position such that the opening of the cavity is left completely open or is closed only partially by the sealing surface. Likewise, the third position of the rotating planetary carrier or rotating ring gear is such that the opening of the cavity is left completely open or only partially closed. In contrast, in the second position of the rotating planetary carrier or the rotating ring gear the opening of the cavity is completely closed off by the sealing surface.

The volume enclosed in the structure, which constitutes the cavity, is an air and/or oil volume. The volume can consist entirely of air, entirely of oil, or air in a first part and oil in a second part. When the rotating planetary carrier or the rotating ring gear is in the first position and a sufficient reserve of oil is present, i.e. when the transmission is filled with a suitable quantity of oil, oil passes out of the oil reservoir through the opening into the cavity. The volume that previously consisted of air then consists at least partially of oil.

Since relative to the rotating planetary carrier or the rotating ring gear the cavity is arranged in a rotationally fixed manner, the cavity too adopts a first position when the rotating planetary carrier or rotating ring gear is in the first position.

If after passing the second position the rotating planetary carrier or the rotating ring gear finally get to the third position, the oil that makes its way into the cavity in the first position flows out of the cavity through the opening. Preferably this happens by virtue of gravity and/or a centrifugal force acting on the oil as a result of the rotation of the rotating planetary carrier or rotating ring gear, which oil at least partially forms the volume enclosed in the structure.

For the oil to flow out of the cavity under gravity, at least part of the opening can be arranged relative to the cavity inward in the radial direction. The effect of arranging the opening relative to the cavity at least partially outward in the radial direction is that the oil flows out of the cavity by virtue of centrifugal force.

When the rotating planetary carrier or the rotating ring gear is in the third position, the cavity too is in a third position,

According to the invention, when the rotating planetary carrier or rotating ring gear is in the second position, the opening is closed off by the sealing surface. It is particularly preferable for the opening to be closed in an oil-tight manner, so that the oil that has passed into the cavity through the opening in the first position of the rotating planetary carrier or rotating ring gear, which consequently forms at least part of the volume enclosed in the structure, cannot flow out of the cavity. Only when the rotating planetary carrier or rotating ring gear is in the third position is the opening, which was closed off by the sealing surface in the second position, opened up so that the oil can flow out of the cavity in a controlled manner.

Preferably, there is not only a single position of the rotating planetary carrier or the rotating ring gear in which the opening is closed off by the sealing surface. Instead, the opening is preferably at least partially closed off in any position adopted by the rotating planetary carrier or rotating ring gear when it moves by rotation from the first position to the third position. Thus, when the rotating planetary carrier or rotating ring gear is in the first position and rotates farther in the direction toward the third position, the sealing surface passes in front of the opening of the cavity so that the opening is initially at least partially closed off.

Finally the opening is completely closed off. The sealing surface is preferably arranged in such manner that during the rotation of the rotating planetary carrier or rotating ring gear, as the rotation continues the opening moves along the sealing surface and during this, remains completely closed off.

Before the rotating planetary or rotating ring gear has reached the third position, the sealing surface opens up the opening of the cavity progressively. Thus, the opening of the cavity remains only partially closed off by the sealing surface before it is finally opened up completely.

In a preferred further development, the transmission comprises at least one oil line and at least one lubrication site, i.e. a component to be lubricated, which has to be supplied with oil. The oil line is designed such that oil flowing out of the cavity through the opening when the rotating planetary carrier or rotating ring gear is in the third position, is delivered to the lubrication site.

In particular, the transmission can have a second cavity for collecting oil. The second cavity has an opening that extends at least partially horizontally, i.e. not completely vertically, through which the oil can flow into the second cavity when the rotating planetary carrier or the rotating ring gear is in the third position. Thus, the second cavity is designed as a collection space for the oil. Preferably the oil line branches off from the second cavity, so that the oil passes from the second cavity into the oil line and is conveyed by the oil line to the lubrication site.

For the lubrication mechanism so designed to be suitable as an emergency lubricating device, it can preferably be activated and deactivated. During normal operation, i.e. when the electric lubricant pump is working properly, the oil line should be closed. On the other hand, if the electric lubricant pump develops a fault, a supply of lubricant via the oil line must be ensured. In a preferred further development, the oil line therefore comprises a switchable valve which, when closed, prevents oil from passing through the oil line, i.e. shuts off the oil line when closed. In the open condition the switchable valve opens up the oil line thus allowing oil to flow through the oil line.

During normal operation the switchable valve is closed. The switchable valve opens for emergency operation, i.e. when the electric oil pump is faulty.

In a further preferred development of the transmission, a first additional element which comprises the cavity is fixed to the rotating planetary carrier or the rotating ring gear. The additional element is attached in a rotationally fixed manner relative to the rotating planetary carrier or rotating ring gear, so that the first additional element and the rotating planetary carrier or rotating ring gear can rotate about a common rotational axis.

Alternatively, the rotating planetary carrier or the rotating ring gear itself can comprise the cavity.

In a further preferred embodiment, besides the transmission housing the transmission comprises at least one second additional element, which has the sealing surface and is attached in a rotationally fixed manner to the transmission housing.

Alternatively, the transmission housing itself can comprise the sealing surface.

The first additional element and/or the second additional element preferably consist of a plastic material. This enables better sealing of the cavity when the opening is closed off by the sealing surface. In particular, the first and/Or the second additional element can be in the form of injection-molded plastic components.

### BRIEF DESCRIPTION OF THE DRAWINGS

Example embodiments of the invention are illustrated in the figures, in which matching indexes denote the same or functionally equivalent features. In detail, the figures show:

FIG. 1: A first variant of an additional element for attachment to a planetary carrier;

FIG. 2: A cavity of the additional element;

FIG. 3: A second variant of an additional element for attachment to a planetary carrier;

FIG. 4: A transmission housing with a sealing surface; and

FIG. 5: A recess for collecting oil.

### DETAILED DESCRIPTION OF THE PREFERRED EMBODIMENTS

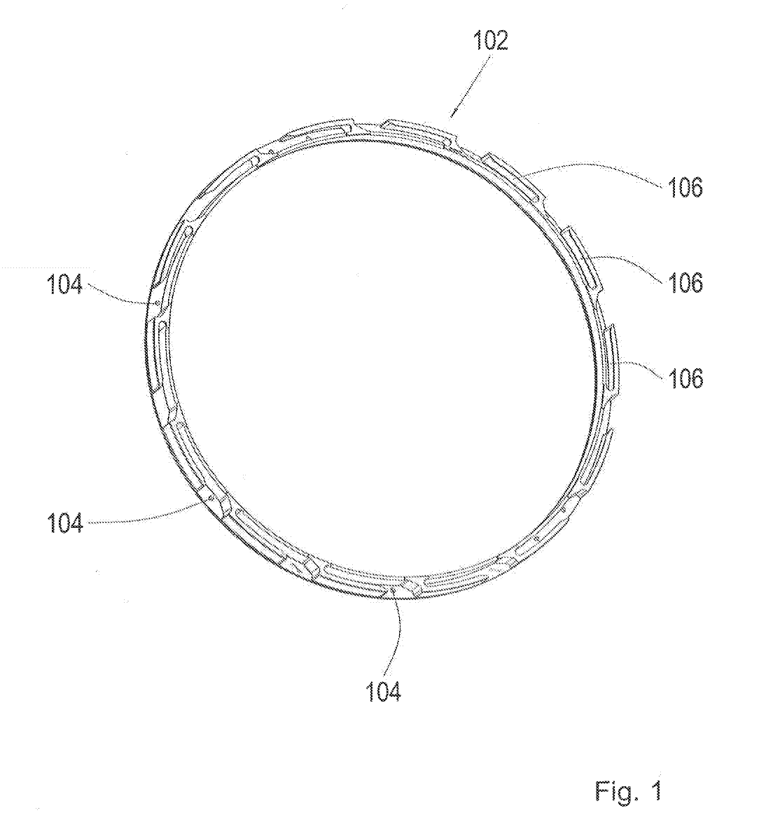

FIG. 1 shows a first additional element designed as an oil conveying ring 102. The oil conveying ring 102 can be screwed to a planetary carrier. For that purpose the oil conveying ring 102 has holes 104.

The oil conveying ring 102 forms a series of cavities 106. By varying the number of cavities, the quantity of oil conveyed during each rotation of the planetary carrier can be adapted.

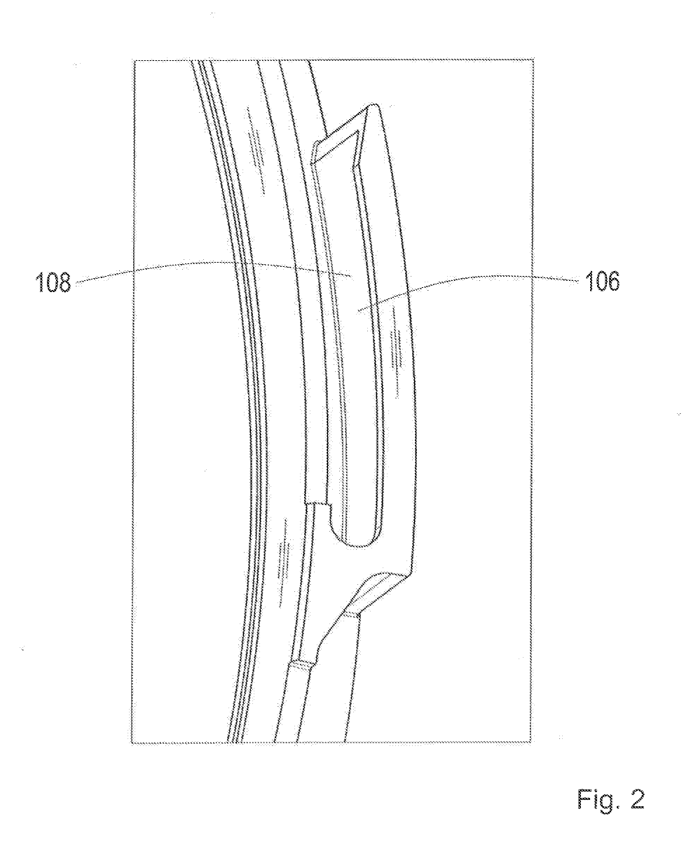

Such a cavity 106 is shown in detail in FIG. 2. The cavity 106 is open in the axial direction relative to the picture plane of FIGS. 1 and 2 and toward the outside in the radial direction.

The oil conveying ring 102 shown in FIGS. 1 and 2 is designed for a planetary carrier rotating to the left as viewed in FIGS. 1 and 2, i.e. counter-clockwise. An opening 108 of the cavity 106 is designed such that as a result of the rotation of the oil conveying ring 102, oil flows into the cavity 106 when the cavity 106 moves through an oil reservoir.

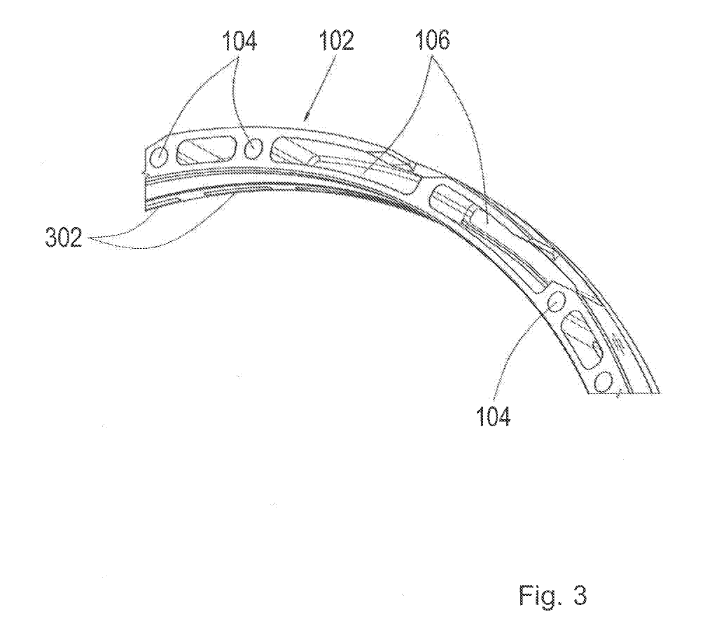

The variant of the oil conveying ring 102 shown in FIG. 3 is screwed to the planetary carrier in such manner that the planetary carrier closes off the axially directed opening 108 of the cavity 106. As viewed from the perspective of FIG. 3, the planetary carrier—not shown in FIG. 3—would therefore be in front of the oil conveying ring 102.

As shown in FIG. 3, the cavities 106 have additional openings 302. These are directed inward in the radial direction.

The individual cavities 106 are designed differently, so as to ensure reliable conveying of oil during changing operation, in particular alternating operation of the oil conveying ring 102 as its rotational speeds change direction.

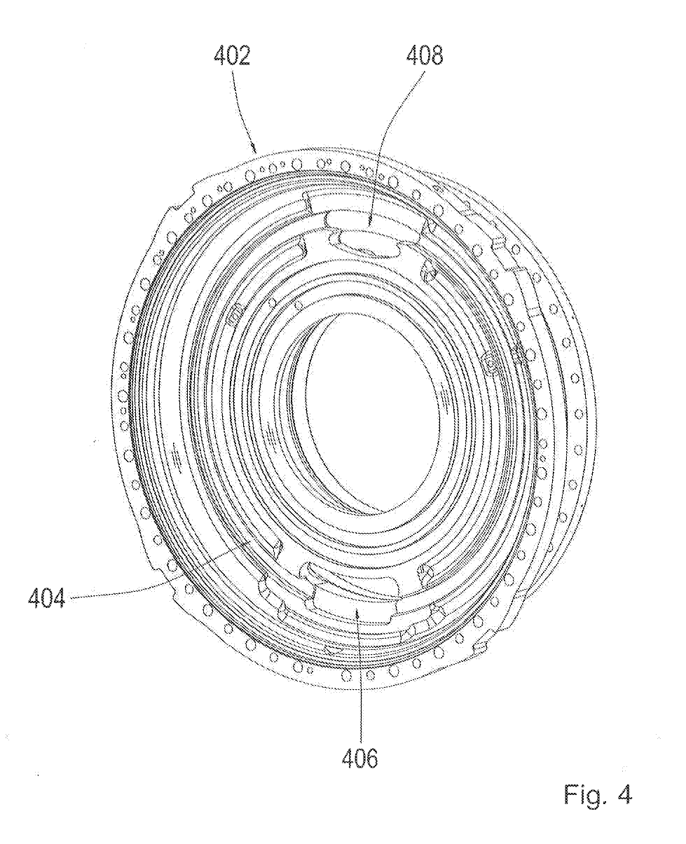

FIG. 4 shows a transmission housing 402 with sealing surfaces 404. The sealing surfaces 404 serve to close off the cavities 106 in an oil-tight manner. Depending on the design of the cavities 106, one or more sealing surfaces 404 can be provided. The sealing surfaces 404 run along a circular path whose mid-point lies on the rotation axis of the planetary carrier, and extend from an oil collection point 406 to an oil delivery point 408.

The oil collection point 406 is arranged so that it is at least partially below the oil level in an oil reservoir. No sealing surface is provided in the oil collection area, so at that point oil can flow into the cavities 106. When a cavity 106 filled with oil reaches the area of the sealing surfaces 404, the cavity 106 is closed off by the sealing surface 404 so that the oil remains enclosed in the cavity 106.

In the oil delivery area 408 no sealing surface is provided. Consequently, there the openings 108, 302 of the cavities 106 are left open so that the oil can flow out of the cavities 106.

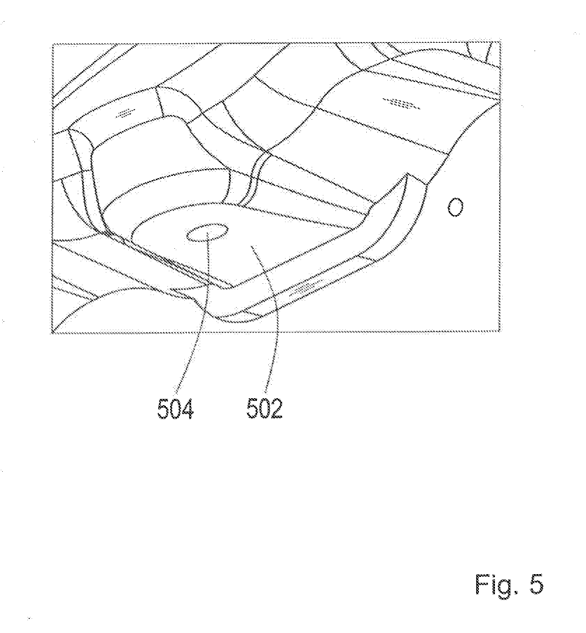

The oil flowing out is collected by a recess 502 shown in FIG. 5. At the bottom of the recess 502 there is a hole 504 through which the oil can flow away. The hole 504 is the inlet of a line through which the oil passes on to a lubrication site.

### INDEX

102 Oil conveying ring
104 Hole
106 Cavity
108 Opening
302 Opening
402 Transmission housing
404 Sealing surface
406 Oil collection area
408 Oil delivery area
502 Recess
504 Hole

1-11. (canceled)

12. A transmission with at least one planetary gearset with at least one positionally fixed sealing surface (404) and with at least one cavity (106);
the planetary gearset comprising a rotating planetary carrier or a rotating ring gear;
the cavity (106) being arranged in a rotationally fixed manner relative to the rotating planetary carrier or the rotating ring gear, and comprising at least one opening (108, 302);
the transmission being designed to accommodate an oil reservoir;
the rotating planetary carrier or the rotating ring gear being adoptable to at least a first position, at least a second position and at least a third position;
the rotating planetary carrier or the rotating ring gear being movable, by rotation, from the first position to the second position and from the second position to the third position;
oil from the oil reservoir being flowable through the opening (108, 302) into the cavity (106), when the rotating planetary carrier or the rotating ring gear is in the first position;
the oil flowing through the opening (108, 302) out of the cavity (106), when the rotating planetary carrier or the rotating ring gear is in the third position; and
the opening (108, 302) being closed off by the sealing surface (404), when the rotating planetary carrier or the rotating ring gear is in the second position.

13. The transmission according to claim 12, further comprising:
at least one oil line and at least one lubrication site;
the oil line delivers the oil flowing through the opening (108, 302) out of the cavity (106) to the lubrication site, when the rotating planetary carrier or the rotating ring gear is in the third position.

14. The transmission according to claim 13, wherein the oil line comprises a switchable valve which, in a closed condition, prevents the oil line from letting any oil through.

15. The transmission according to claim 12, further comprising at least one first additional element (102) which comprises the cavity (106), and the at least one first additional element (102) is fixed onto the rotating planetary carrier or the rotating ring gear.

16. The transmission according to claim 12, wherein the rotating planetary carrier or the rotating ring gear comprises the cavity (106).

17. The transmission according to claim 15, further comprising at least one second additional element and a transmission housing (402), the second additional element comprises the sealing surface (404) and is fixed onto the transmission housing (402).

18. The transmission according to claim 12, further comprising a transmission housing (402) which comprises the sealing surface (404).

19. A first additional element (102) of a transmission according to claim 15.

20. A planetary carrier or ring gear of a transmission according to claim 16.

21. A second additional element of a transmission according to claim 17.

22. A transmission housing (402) of a transmission according to claim 18.

23. A transmission with one planetary gearset with at least one positionally fixed sealing surface and with at least one cavity;
the planetary gearset comprising a rotating planetary carrier or a rotating ring gear;
the cavity being arranged in a rotationally fixed manner relative to the rotating planetary carrier or the rotating ring gear, and comprising at least one opening;
the transmission accommodating an oil reservoir accommodating oil;
the rotating planetary carrier or the rotating ring gear having at least a first position, a second position and a third position;
the rotating planetary carrier or the rotating ring gear being movable, by rotation, from the first position to the second position and from the second position to the third position;
the oil from the oil reservoir being flowable through the opening into the cavity, when the rotating planetary carrier or the rotating ring gear is in the first position;
the oil flowing through the opening out of the cavity, when the rotating planetary carrier or the rotating ring gear is in the third position; and
the opening being closed by the sealing surface, when the rotating planetary carrier or the rotating ring gear is in the second position.

24. A transmission having a planetary gearset with a planetary carrier and ring gear which are rotatable with respect to an annular, fixed sealing surface, the sealing surface having an oil collection point and an oil delivery area, the transmission comprising:
an oil conveying ring being securable to one of the planetary carrier and the ring gear such that oil conveying ring is rotatable in unison with the one of the planetary carrier and the ring gear from a first rotational position to a second rotational position and from the second rotational position to a third rotational position;
the oil conveying ring comprising a plurality of cavities arranged about the oil conveying ring;
each of the cavities having an opening that is open in an axial direction;
the oil conveying ring being rotatable with respect to the fixed sealing surface such that:
in the first rotational position of the oil conveying ring, at least one of the cavities being axially aligned with the oil collection point of the sealing surface in an open condition such that oil flows into the at least one of the cavities from the oil collection point,
in the second rotational position of the oil conveying ring, the at least one of the cavities being axially aligned with the sealing surface, in a closed condition, such that oil is prevented from flowing either into or out of the at least one of the cavities, and
in the third rotational position of the oil conveying ring, the at least one of the cavities being axially aligned with the oil delivery area of the sealing surface such that oil flows out from the at least one of the cavities into the oil delivery area.
